(19) United States
(12) Patent Application Publication
(10) Pub. No.: US 2006/0026999 A1
(43) Pub. Date: Feb. 9, 2006

(54) Apparatus for feeding and discharging liquid contents in a fulling vat for the treatment of hides and skins

(76) Inventor: Luis Cesio Caccialli, Montevideo (UY)

Correspondence Address: QUARLES & BRADY LLP, 411 E. WISCONSIN AVENUE, SUITE 2040, MILWAUKEE, WI, 53202-4497, US

(21) Appl. No.: 11/242,410

(22) Filed: Oct. 3, 2005

Related U.S. Application Data
(63) Continuation-in-part of application No. 10/855,475, filed on May 27, 2004.

(30) Foreign Application Priority Data
Nov. 10, 2004 (UY) U 4038

(51) Int. Cl. C14C 15/00; C14C 1/00

(52) U.S. Cl. 69/29

(57) ABSTRACT

A new mechanism for feeding and discharging liquid contents in fulling vats for the treatment of hides and skins, which is provided with internal and external ducts connected from outside the vat to crosspieces, said crosspieces having multiple orifices circular in shape and being provided at their ends with valves for the inflow and draining of liquid substances.

### CROSS-REFERENCE TO RELATED APPLICATION

This is a continuation-in-part of U.S. patent application Ser. No. 10/855,475, now pending entitled “Spiral System Reactor for the Treatment of Hides and Skins.”

### BACKGROUND OF THE INVENTION

The innovation claimed as patentable improves procedures for feeding and discharging liquids and solid chemicals in a process for the treatment of hides and skins carried out by using a fulling reactor suitable to that end.

### SUMMARY OF THE INVENTION

The fulling vat or spiral system reactor which is referred to in this innovation carries out a mechanical process for the treatment of animal hides and skins (steeping, hair scraping, tanning, retanning, currying and other steps), and the course of said process involves the use of liquid feeds introduced through one end of the hollow shaft of the device. When the use of solid chemicals is required, said chemicals are usually introduced and drawn off through the same loading and unloading gate used for the hides and skins and are then gradually dissolved by the motion of the vat. Bearing in mind the fact that hides and skins are extremely sensitive to sudden changes or shifts in conditions (physical, thermal, hydric and tonic shocks), the invention provides for the use of hollow perforated crosspieces which reduce to a minimum the effects of shock, by the following means:
slow rotation, to prevent sudden blows or clashes;
thermostatic controls and regulators which prevent thermal shock;
perforated crosspieces which reduce to a minimum both hydric shock (occasional sudden pH variations) and tonic shock (variations in concentration).

The provision of perforated holes in the crosspieces offers not only the above advantages during the feeding step, but also ensures at the time of draining a faster drawing off of exhausted liquids (thus allowing for shorter “idle” time in the fulling vat).

Water and chemicals for the treatment of hides and skins flow into the reactor by means of valves placed at the side of the crosspieces, which have a great number of orifices. Likewise, water and chemicals are drawn off through said orifices, which act like a sprinkler facilitating a homogeneous distribution of treatment products, and also allow a faster drawing off of liquid after the process operations have been completed.

### BRIEF DESCRIPTION OF THE DRAWINGS

FIGS. 1 and 2 are side views in elevation of a vat of the present invention; and

FIGS. 3 and 4 are transverse sectional views of the vat seen in FIG. 1.

### DETAILED DESCRIPTION

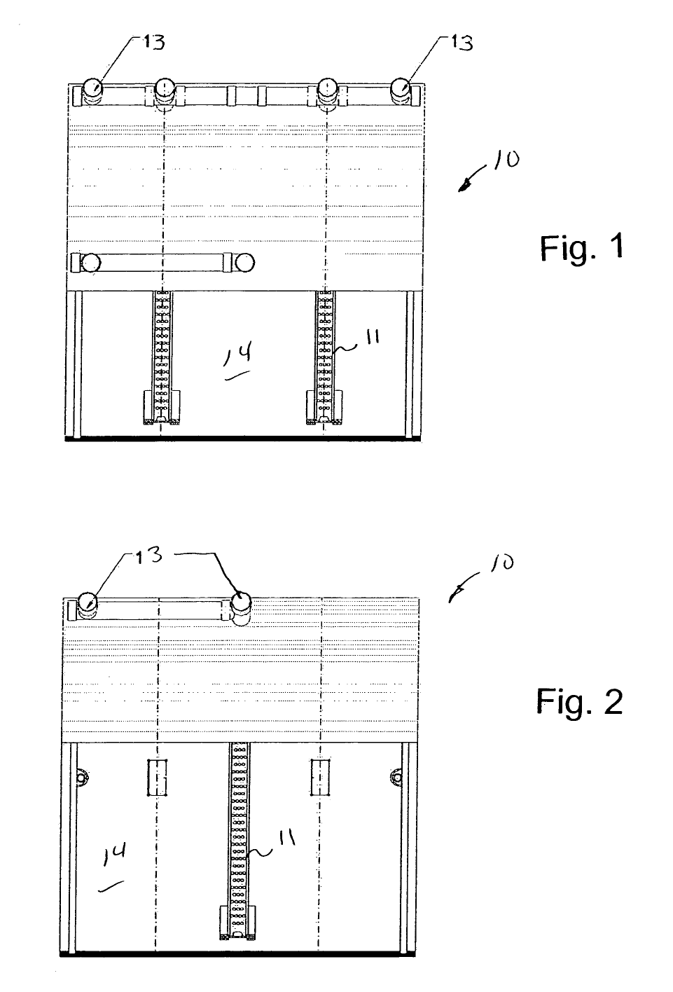

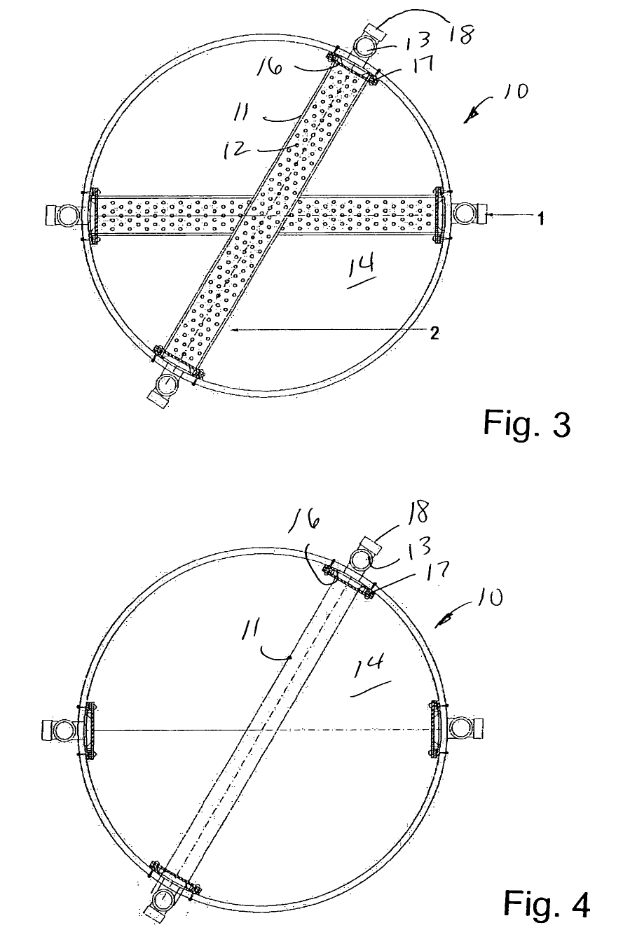

As can be seen from FIGS. 1-4 which illustrate one embodiment of the invention, all crosspieces 11 set inside the fulling vat 10 have perforation holes 12 on their four sides, uniformly distributed and circular in shape. Background disclosure for this invention is provided by my copending U.S. patent application Ser. No. 10/855,475, including U.S. Pat. Pub. No. U.S. 2005/0034245, published Feb. 17, 2005, entitled “Spiral System Reactor for the Treatment of Hides and Skins,” the disclosure of which is hereby incorporated by reference.

Liquids flow into the crosspieces 11 through inner and external ducts 13 connected thereto, and through said crosspieces 11 are poured into a chamber 14 in the vat 10 through the orifices 12. In the opposite case, when the active process has been completed by the device, liquids are drawn off into the crosspieces 11 through said orifices 12, and each crosspiece 11 is provided at its end with a valve 18 connected to a duct passageway 13 which in turn leads to an external valve (not shown) for final draining.

I claim:

1. Apparatus for feeding and discharging liquid contents in fulling vats for the treatment of hides and skins, said apparatus comprising inner and external ducts which are from outside the vat connected to the crosspieces within.

2. The apparatus as recited in claim 1, wherein said crosspieces having multiple orifices circular in shape and being provided at their ends with valves for the inflow and draining of liquid substances.
